(19) United States
(12) Patent Application Publication
(10) Pub. No.: US 2012/0150955 A1
(43) Pub. Date: Jun. 14, 2012

(54) Contact Resolution Using Social Graph Information

(76) Inventor: Erick Tseng, San Francisco, CA (US)

(21) Appl. No.: 12/965,094

(22) Filed: Dec. 10, 2010

(51) Int. Cl. G06F 15/16

(52) U.S. Cl. 709/204

(57) ABSTRACT

In one embodiment, a social networking system imports a user's contacts to a local address book of the user by merging the user's social graph information to the local address book.

### TECHNICAL FIELD

The present disclosure relates generally to a network communications services and, more particularly, to merging a user's address book with the user's social graph information.

### BACKGROUND

A social networking system, such as a social networking website, enables its users to interact with it and with each other through the system. The social networking system may create and store a record, often referred to as a user profile, in connection with the user. The user profile may include a user's demographic information, communication channel information, and personal interest. The social networking system may also create and store a record of a user's relationship with other users in the social networking system (e.g., social graph), as well as provide services (e.g., wall-posts, photo-sharing, or instant messaging) to facilitate social interaction between users in the social networking system. For example, a user of a social networking website can access an address book stored in the social networking website, look up a contact in the address book and connect with the contact through email.

### SUMMARY

Particular embodiments relate to leveraging social graph information to merge and/or synchronize a user's address book with user profile information. These and other features, aspects, and advantages of the disclosure are described in more detail below in the detailed description and in conjunction with the following figures.

### BRIEF DESCRIPTION OF THE DRAWINGS

FIG. 1 illustrates an example social networking system.

FIG. 2 illustrates an example social graph and an example local address book.

FIG. 3 illustrates an example method of contact resolution using social graph information.

FIG. 4 illustrates an example network environment.

FIG. 5 illustrates an example computer system.

### DETAILED DESCRIPTION

The invention is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A social networking system, such as a social networking website, enables its users to interact with it, and with each other through, the system. Typically, to become a registered user of a social networking system, an entity, either human or non-human, registers for an account with the social networking system. Thereafter, the registered user may log into the social networking system via an account by providing, for example, a correct login ID or username and password. As used herein, a “user” may be an individual (human user), an entity (e.g., an enterprise, business, or third party application), or a group (e.g., of individuals or entities) that interacts or communicates with or over such a social network environment.

When a user registers for an account with a social networking system, the social networking system may create and store a record, often referred to as a “user profile”, in connection with the user. The user profile may include information provided by the user and information gathered by various systems, including the social networking system, relating to activities or actions of the user. For example, the user may provide his name, contact information, birth date, gender, marital status, family status, employment, education background, preferences, interests, and other demographical information to be included in his user profile. The user may identify other users of the social networking system that the user considers to be his friends. A list of the user's friends or first degree contacts may be included in the user's profile. Connections in social networking systems may be in both directions or may be in just one direction. For example, if Bob and Joe are both users and connect with each another, Bob and Joe are each connections of the other. If, on the other hand, Bob wishes to connect to Sam to view Sam's posted content items, but Sam does not choose to connect to Bob, a one-way connection may be formed where Sam is Bob's connection, but Bob is not Sam's connection. Some embodiments of a social networking system allow the connection to be indirect via one or more levels of connections (e.g., friends of friends). Connections may be added explicitly by a user, for example, the user selecting a particular other user to be a friend, or automatically created by the social networking system based on common characteristics of the users (e.g., users who are alumni of the same educational institution). The user may identify or bookmark websites or web pages he visits frequently and these websites or web pages may be included in the user's profile.

The user may provide information relating to various aspects of the user (such as contact information and interests) at the time the user registers for an account or at a later time. Contact information may include mailing addresses, neighborhood, telephone numbers, email addresses, instant messaging, chat and/or VoIP system identifiers, websites, and the like. The user may also update his or her profile information at any time. For example, when the user moves, or changes a phone number, he may update his contact information. Additionally, the user's interests may change as time passes, and the user may update his interests in his profile from time to time. A user's activities on the social networking system, such as frequency of accessing particular information on the system, may also provide information that may be included in the user's profile. Again, such information may be updated from time to time to reflect the user's most-recent activities. Still further, other users or so-called friends or contacts of the user may also perform activities that affect or cause updates to a user's profile. For example, a contact may add the user as a friend (or remove the user as a friend). A contact may also write messages to the user's profile pages—typically known as wall-posts. A user may also input status messages that get posted to the user's profile page.

A social network system may maintain social graph information, which can generally model the relationships among groups of individuals, and may include relationships ranging from casual acquaintances to close familial bonds. A social network may be represented using a graph structure. Each node of the graph corresponds to a member of the social network. Edges connecting two nodes represent a relationship between two users. In addition, the degree of separation between any two nodes is defined as the minimum number of hops required to traverse the graph from one node to the other. A degree of separation between two users can be considered a measure of relatedness between the two users represented by the nodes in the graph.

The social networking system may also support a privacy model. A user may or may not wish to share his information with other users or third-party applications, or a user may wish to share his information only with specific users or third-party applications. A user may control whether his information is shared with other users or third-party applications through privacy settings associated with his user profile. For example, a user may select a privacy setting for each user datum associated with the user and/or select settings that apply globally or to categories or types of user profile information. A privacy setting defines, or identifies, the set of entities (e.g., other users, connections of the user, friends of friends, or third party application) that may have access to the user datum. The privacy setting may be specified on various levels of granularity, such as by specifying particular entities in the social network (e.g., other users), predefined groups of the user's connections, a particular type of connections, all of the user's connections, all first-degree connections of the user's connections, the entire social network, or even the entire Internet (e.g., to make the posted content item index-able and searchable on the Internet). A user may choose a default privacy setting for all user data that is to be posted. Additionally, a user may specifically exclude certain entities from viewing a user datum or a particular type of user data. For example, a user may select a setting that allows only first-degree friends or contacts to access a user's contact information. In some implementations, the granularity of privacy controls can be configured to allow the user to allow access to some contact information (e.g., a business email address) to a broader set of users, while restricting access to more sensitive contact information (e.g., personal cell phone number, personal email address, etc.) to a narrower set of users.

In addition to user profile information, the social networking system may track or maintain other information about the user. For example, a geo-social networking system is a social networking system that hosts one or more location-based services that record the user's location. For example, users may access the geo-social networking system using a special-purpose client application hosted by a mobile device of the user. The client application may automatically access Global Positioning System (GPS) or other geo-location functions supported by the mobile device and report the user's current location to the geo-social networking system. In addition, the client application may support geo-social networking functionality that allows users to check-in at various locations and communicate this location to other users. For example, social network system may post information describing a user's check-in to the user's profile page, which may cause the information to be included in newsfeeds of other users of the social networking system. In other implementations, the social networking system may add the information to such news feeds without posting it to a user profile page. The user may also add, delete or update events that the user is associated with. For example, a user may update a social event associated with a time and date that the user is planning to attend, or make comments in his wall-posts about a past event he attended.

Additionally, social networking system may provide various communication channels for users to interact with each other. In addition, other communications channels not intermediated or facilitated by the social networking system also allow users to interact. Thus, users of a social networking system may interact with each other by sending and receiving content items of various types of media through the communication channels. In particular embodiments, communication channels may include, but are not limited to, email, instant messaging (IM), text, voice or video chat, and wall posts. A user of the social networking system may also interact through various communication channels outside the social networking system with another person (a user or non-user of the social networking system). Examples of those communication channels are phone call though public switched telephone network (PSTN) or the Internet (e.g., VOIP or voice over internet protocol), text, voice or video chat, SMS (short message service) text messaging, instant messaging, and email.

To keep track of communication channel information, a user of the social networking system may keep one or more address books. An address book may contain one or more contacts (e.g., a person or a business identify) and for each contact, a name and communication channel information for the contact (e.g., a phone number, a user ID for an IM service, an email address, a user ID for a social networking system, home address, etc.). In some implementations, a user of a social networking system may add all or any of his friends or contacts to his address book. In one implementation, the contact information that the social networking system maintains for each friend (see above) may be imported into the address book or accessed as needed. A user of the social networking system may keep the one or more address books inside or outside the social networking system. For example, the social networking system may maintain an address book for a user, and the user can access the address book though the social networking system's web site, or through a client application hosted by a client device 122. For example, a user may keep an address book in connection with a client application hosted locally by the user's personal computer (e.g., Microsoft Outlook), or keep an address book in a native address book application supported by the user's mobile phone. For example, a user may keep an address book hosted over the Internet by a remote server (i.e., the address book is hosted “in the cloud”) and access the address book via a web browser on a client device 122. In other implementations, an address book database may be synchronized between the client device 122 and the social network system.

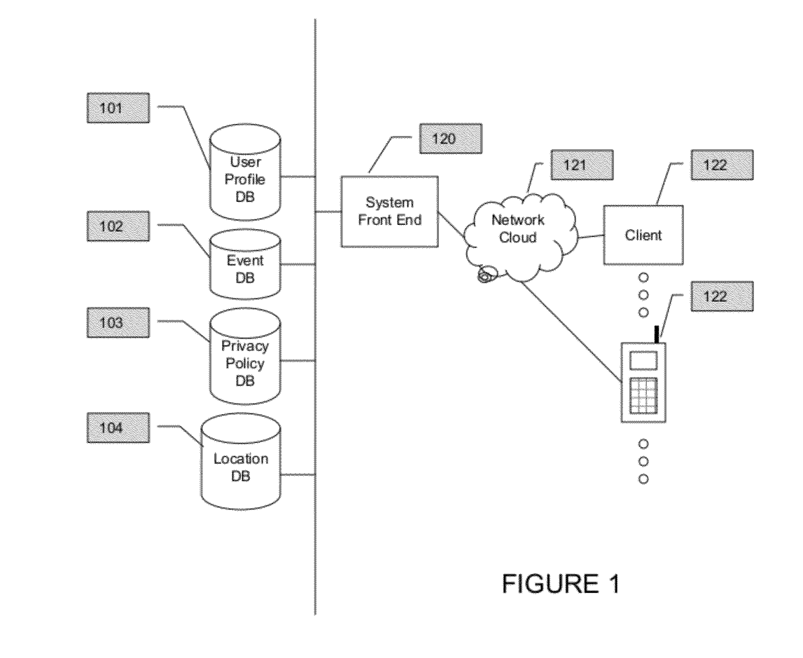

FIG. 1 illustrates an example social networking system. In particular embodiments, the social networking system may store user profile data and social graph information in user profile database 101. In particular embodiments, the social networking system may store user event data in event database 102. In particular embodiments, the social networking system may store user privacy policy data in privacy policy database 103. In particular embodiments, the social networking system may store geographic and location data in location database 104. In particular embodiments, databases 101, 102, 103, and 104 may be operably connected to the social networking system's front end 120. In particular embodiments, the front end 120 may interact with client device 122 through network cloud 121. Client device 122 is generally a computer or computing device including functionality for communicating (e.g., remotely) over a computer network. Client device 122 may be a desktop computer, laptop computer, personal digital assistant (PDA), in- or out-of-car navigation system, smart phone or other cellular or mobile phone, or mobile gaming device, among other suitable computing devices. Client device 122 may execute one or more client applications, such as a web browser (e.g., Microsoft Windows Internet Explorer, Mozilla Firefox, Apple Safari, Google Chrome, and Opera, etc.) or special-purpose client application (e.g., Facebook for iPhone, etc.), to access and view content over a computer network. Front end 120 may include web or HTTP server functionality, as well as other functionality, to allow users to access the social networking system. Network cloud 121 generally represents a network or collection of networks (such as the Internet or a corporate intranet, or a combination of both) over which client devices 122 may access the social network system.

In particular embodiments, user profile database 101 may store communication channel information and an address book of a user. The address book, in one implementation, may be a superset or a subset of the users of the social networking system that a user has established a friend or contact relationship. A user of client device 122 may access this address book information using a special purpose or general purpose client application to view contact information. In particular embodiments, the address book may contain one or more contacts (e.g. a person or an business entity), and a name (e.g., first name, and/or last name) and communication channel information for each contact (e.g., a phone number, a user ID for an IM service, an email address, a user ID for a social networking system, home address, etc.). For at least a portion of the address book information, the contact entries may be dynamic in that the contact entry is associated with a user of the social networking system that maintains his or her own account and corresponding user profile with contact information. Accordingly, when a first user changes any aspect of contact information, the revised contact information may be provided to requesting users. In particular embodiments, a user may access the address book, look up and connect to a contact through a communication channel.

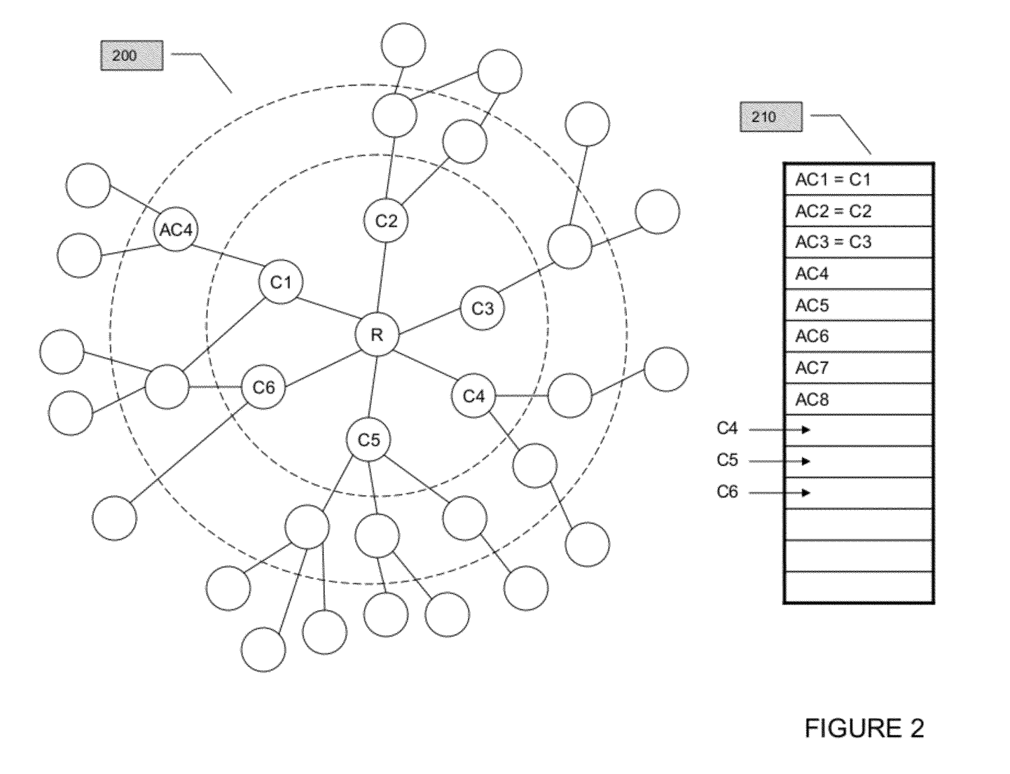

A user of the social networking system can transfer or synchronize contacts in the address book stored in user profile database 101 to an address book outside the social networking system, e.g., to a native address book application supported by the user's mobile phone. However, two address books of a same person oftentimes can have different sets of contacts and contact information. FIG. 2 illustrates an example social graph and an example graphic illustrating a relationship between the social graph and a local address book. In the example of FIG. 2, a user, Robert, has a social graph 200 in the social networking system and a local address book 210 (e.g., an address book hosted on Robert's mobile phone). Robert may also have an address book stored in user profile database 101 that contains 6 users that are one degree of separation from Robert (C1, C2, . . . , C6). On the other hand, Robert can have 8 contacts (AC1, AC2, . . . , AC8) in the local address book. As in this example, the two address books can have different sets of contacts where some are identical (AC1=C1, AC2=C2, AC3=C3) and some exist in one address book but not in the other (e.g., C4, C5 and C6 are not in the local address book). Ordinarily when importing contacts from a first address book to a second address book, a contact in the first address book can be duplicated in the second address book if no matching name of the contact can be found in the second address book. However, this can occur when the contact does exist in the second address book but with a slightly different name (e.g., “Bob Johnson” in the first address book vs. “Rob Johnson” in the second address book), or the contact having different names due to context (e.g., “Nancy Smith” in a social networking system vs. “Mom” in a phone's native address book). Particular embodiments herein describe methods in resolving differences in contacts between two address books by using social graph information.

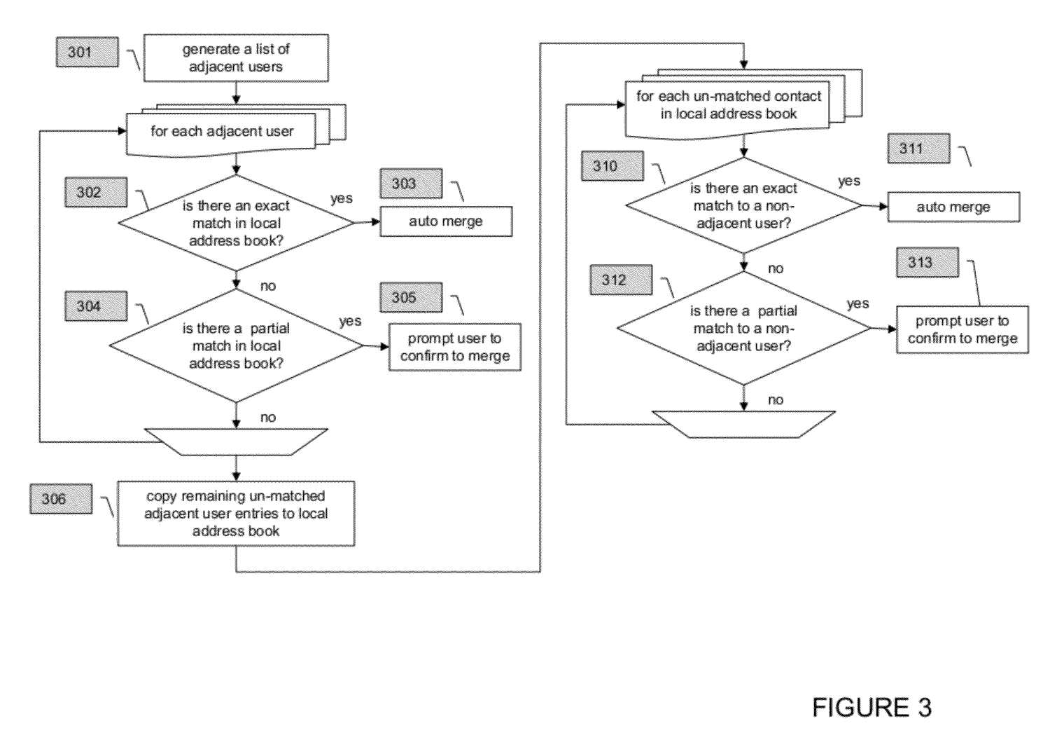

FIG. 3 illustrates an example method of contact resolution using social graph information to aid in synchronization and merging operations. FIG. 3 can be implemented by a contact-importing process hosted on one or more computing devices of the social networking system and/or a user's device, such as a mobile phone or laptop. For example, all data sets described herein can be uploaded to a server of the social networking system for processing with the results being sent to a client device. In other implementations, the client device may receive the data and perform the operations described herein. In other implementations, processing may be distributed between client and server. In particular embodiments, the contact-importing process may receive a request from a requesting user to import the address book stored in user profile database 101 to a local address book. For example, the requesting user can access a local address book application hosted on the requesting user's client device 122, causing the contact-importing process to import the address book stored in user profile database 101 to the local address book. In other implementations, the requesting user can access a special-purpose client application (e.g., Facebook for iPhone, etc.) on the requesting user's client device 122, causing the contact-importing process to import the address book stored in user profile database 101 to a local address book hosted on the client device 122. In another implementation, the requesting user can access, via a web browser on a client device 122, a local address book hosted on a remote server, causing the contact-importing process to import communication channel information from user profile database 101 to the local address book.

In particular embodiments, the contact-importing process may access the social graph to generate a list of socially adjacent users relative to the requesting user (301). In particular embodiments, a socially adjacent user may be a user who is one degree of separation from the requesting user in a social graph (e.g., C1, C2, C3, C4, C5, and C6 in FIG. 2). In one implementation, the list of socially adjacent users are limited to the first-degree friends or contacts of the user that have been explicitly added to an address book of the user maintained in user profile database 101 on the social networking system. In another implementation, the address book of the user profile includes, by default, all first degree contacts of the user are included in the address book maintained for the user in connection with his or her user profile.

In particular embodiments, the contact-importing process may, for each user in the list of socially adjacent users, determine whether there is an exact match to a contact in the local address book (302). In particular embodiments, the contact-importing process may determine where there is an exact match between an entry for a user of the social networking system (referred to herein as a “user entry”) and a contact entry in the local address book (referred to herein as a “contract entry”) by assessing whether there is an exact match in names and/or in one or more items of associated communication channel information between the user entry and the contact entry. For example, the contact-importing process can determine an exact match if the user entry and the contact entry have the same name “Bob Johnson”. For example, the contact-importing process can determine an exact match if the user entry has a name “Nancy Smith” and a phone number “555-5555”, and the contact entry has a name “Mom” and a cell phone number “555-5555”. In particular embodiments, if the contact-importing process determines an exact match between a user entry and a contact entry, the contact-importing process may merge communication channel information of the user entry and the contact entry (303). In particular embodiments, the contact-importing process may merge communication channel information of user entry and the contact entry by copying all or a portion of the particular user's communication channel information of the user entry to the contact entry of the local address book. For example, the user's local address book may have a phone number for a given contact, while the social networking system may include an email address and possibly other contact information. The importing process may add the email address to the local address book. In some implementations, the contact importing process may also download a thumbnail version of a profile picture of the user for use by applications that access the local address book. In some implementations, the contact-importing process may also selectively synchronize various contact entry attributes based on time stamps associated with the corresponding entries in the local address book and the communications channel information maintained by the social networking system. For example, the name attribute of a contact entry in the local address book may remain unchanged, while a new cell phone number entry will be changed. In some implementations, the contact-importing process may selectively synchronize various contact entry attributes based on sources associated with the corresponding entries in the local address book. For example, the user's local address book may include a home phone number 555-5555 for a particular contact, while the social networking system may include a home phone number 777-7777 from the same particular contact's user profile—i.e., the home phone number 777-7777 was entered by the particular contact himself. The contact-importing process may copy the home phone number from the social networking system (777-7777) to the home phone number entry for the particular contact of the user's local address book, since the home phone number from the social networking system is likely more accurate as it was entered by the particular contact himself. In some implementations, the local address book application may prompt the user to confirm such an operation or ask the user which entry to keep and which to either discard (or whether to create an additional entry). In one implementation, access to a socially adjacent user's communication channel information may be based on privacy settings configured by the particular user. Accordingly, some aspects of communication channel information may be excluded from the merging and synchronization operations described here.

In particular embodiments, if a user entry is not an exact match to a contact entry in the local address book, the contact-importing process may determine whether there is a partial match to a contact entry in the local address book (304). In particular embodiments, the contact-importing process may determine a partial match between a user entry and a contact entry by determining whether there is a partial match in names and/or in one or more communication channels between the user entry and the contact entry. For example, the contact-importing process can identify a partial match if there is a small (e.g., one character or one digit) difference in names or in communication channel information, e.g., “Bob Johnson” vs. “Rob Johnson,” or “Bob J.” vs. “Bob Johnson.” In particular embodiments, the contact-importing process may assign a partial matching score to the user entry. For example, the importing process may assign a score of 0.9 if there is a difference in one character in the first names, or a score of 0.7 if the first names match and the last names partially match. Matching communications channel information or the lack of any matching entries may add to or subtract from the partial matching score based on the type of communications channel information. For example, a matching email address may be more relevant to identifying a match than a matching home or business telephone number that might be shared among many users. In particular embodiments, the contact-importing process may present to the requesting user a user entry that is a partial match to a contact entry in the local address book. In particular embodiments, the contact-importing process may present to the requesting user a user entry that has a partial matching score over a pre-determined threshold (e.g., 0.6). In particular embodiments, if the requesting user confirms a partial match, the contact-importing process may merge and/or synchronize communication channel information of the user entry and the contact entry (305).

In particular embodiments, the contact-importing process may copy remaining one or more un-matched user entries corresponding to socially adjacent users in the list of adjacent users to the local address book (306). Using FIG. 2 as an example, if the contact-importing process determines C1, C2, and C3 have exact match or partial match in the local address book (AC1, AC2, and AC3, respectively), the contact-importing process can copy the remaining adjacent user entries C4, C5, and C6 to the local address book, by copying each remaining adjacent user entry (e.g., a name, communication channel information, profile picture, etc.) to the local address book.

In particular embodiments, the contact-importing process may, for each of one or more remaining un-matched contact entries in the local address book, search for an exact match against one or more users entries associated with users that are not directly adjacent to the requesting user in the social graph of the social networking system (310). In particular embodiments, the users not directly adjacent to the requesting user may be users that are two degrees of separation from the requesting user in the social networking system. In other embodiments, the users not directly adjacent to the requesting user may be users who are two or three degrees of separation from the requesting user in the social networking system. In particular embodiments, the contact-importing process may, for at least one of the unmatched contact entries, search the social graph for one or more users (limited to two or three degrees of separation) whose corresponding user entries have a same or a similar name as an un-matched contact entry.

In one implementation, the search criterion may also include location-related and temporal attributes. For example, the query may further access other user profile data to look for those users that have sufficiently close spatial and temporal proximity overlap to the requesting user (e.g., whether the users attended the same college during at least one academic year, whether the check-in activity in a geo- social network indicate that the users have been at any given place at the same time, where the users currently reside in the same city or other geographic region). In some implementations, the social network system may track the locations of one or more users and store the location history in a data store. For example, users may use geo-social networking functionality to check in to various locations. In addition, a mobile client application hosted on a mobile device of a user may attach location information generated by a GPS module to messages transmitted from the mobile device 122 to the social networking system. In addition, the user may accept an invitation to an event having a known geographic location. In particular embodiments, the contact-importing process may access a location history data store to determine the requesting user's and non-adjacent user's past location information. For example, the location information can be based on a data store of check-in activity maintained by a geosocial networking service, an events service that allows users to configure and register attendance for events, status updates, calendar information and the like. A spatio-temporal match can be based on a determination that the users were in the same geographic location (out to a configurable radius) at the same time as the user (within a configurable window of time) (optionally) all within a configurable overall sliding window of time as measured from a current processing action.

In particular embodiments, if the contact-importing process determines an exact match between a non-adjacent user entry and a contact entry (e.g., AC4 in FIG. 2), the contact-importing process may merge and/or syncrhonize communication channel information of the non-adjacent user entry and the contact entry (311). In one implementation, the contact-importing process may also present to the requesting user a selectable option to send to the non-adjacent user an invitation to become the requesting user's first degree friend in the social networking system. In particular embodiments, if the contact-importing process cannot find an exact match against a non-adjacent user entry for a contact entry of the one or more remaining un-matched contacts entries in the local address book, the contact-importing process may search for a partial match against one or more user entries corresponding to users non-adjacent to the requesting user in the social networking system (312). In particular embodiments, if the requesting user confirms a partial match of a non-adjacent user to a contact in the local address book, the contact-importing process may merge communication channel information of the non-adjacent user entry and the contact entry (313). As above, the contact-importing process may also present to the requesting user a selectable option to send to the non-adjacent user an invitation to become a first degree friend of the requesting user (313).

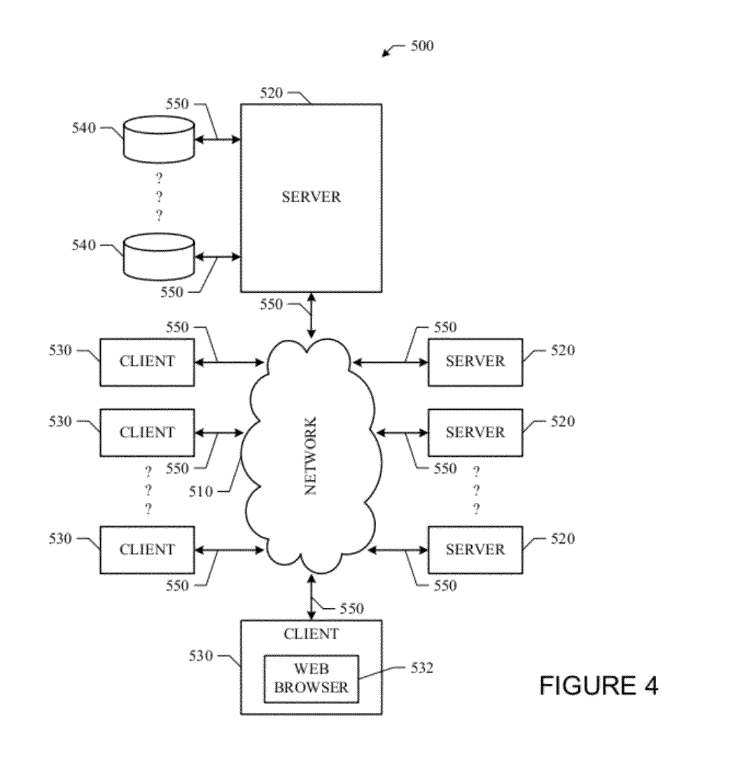

While the foregoing embodiments may be implemented in a variety of network configurations, the following illustrates an example network environment for didactic, and not limiting, purposes. FIG. 4 illustrates an example network environment 500. Network environment 500 includes a network 510 coupling one or more servers 520 and one or more clients 530 to each other. Network environment 500 also includes one or more data storage 540 linked to one or more servers 520. Particular embodiments may be implemented in network environment 500. For example, social networking system frontend 120 may be written in software programs hosted by one or more servers 520. For example, event database 102 may be stored in one or more storage 540. In particular embodiments, network 510 is an intranet, an extranet, a virtual private network (VPN), a local area network (LAN), a wireless LAN (WLAN), a wide area network (WAN), a metropolitan area network (MAN), a portion of the Internet, or another network 510 or a combination of two or more such networks 510. The present disclosure contemplates any suitable network 510.

One or more links 550 couple a server 520 or a client 530 to network 510. In particular embodiments, one or more links 550 each includes one or more wired, wireless, or optical links 550. In particular embodiments, one or more links 550 each includes an intranet, an extranet, a VPN, a LAN, a WLAN, a WAN, a MAN, a portion of the Internet, or another link 550 or a combination of two or more such links 550. The present disclosure contemplates any suitable links 550 coupling servers 520 and clients 530 to network 510.

In particular embodiments, each server 520 may be a unitary server or may be a distributed server spanning multiple computers or multiple datacenters. Servers 520 may be of various types, such as, for example and without limitation, web server, news server, mail server, message server, advertising server, file server, application server, exchange server, database server, or proxy server. In particular embodiments, each server 520 may include hardware, software, or embedded logic components or a combination of two or more such components for carrying out the appropriate functionalities implemented or supported by server 520. For example, a web server is generally capable of hosting websites containing web pages or particular elements of web pages. More specifically, a web server may host HTML files or other file types, or may dynamically create or constitute files upon a request, and communicate them to clients 530 in response to HTTP or other requests from clients 530. A mail server is generally capable of providing electronic mail services to various clients 530. A database server is generally capable of providing an interface for managing data stored in one or more data stores.

In particular embodiments, one or more data storages 540 may be communicatively linked to one or more servers 520 via one or more links 550. In particular embodiments, data storages 540 may be used to store various types of information. In particular embodiments, the information stored in data storages 540 may be organized according to specific data structures. In particular embodiment, each data storage 540 may be a relational database. Particular embodiments may provide interfaces that enable servers 520 or clients 530 to manage, e.g., retrieve, modify, add, or delete, the information stored in data storage 540.

In particular embodiments, each client 530 may be an electronic device including hardware, software, or embedded logic components or a combination of two or more such components and capable of carrying out the appropriate functions implemented or supported by client 530. For example and without limitation, a client 530 may be a desktop computer system, a notebook computer system, a netbook computer system, a handheld electronic device, or a mobile telephone. The present disclosure contemplates any suitable clients 530. A client 530 may enable a network user at client 530 to access network 530. A client 530 may enable its user to communicate with other users at other clients 530.

A client 530 may have a web browser 532, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 530 may enter a Uniform Resource Locator (URL) or other address directing the web browser 532 to a server 520, and the web browser 532 may generate a Hyper Text Transfer Protocol (HTTP) request and communicate the HTTP request to server 520. Server 520 may accept the HTTP request and communicate to client 530 one or more Hyper Text Markup Language (HTML) files responsive to the HTTP request. Client 530 may render a web page based on the HTML files from server 520 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

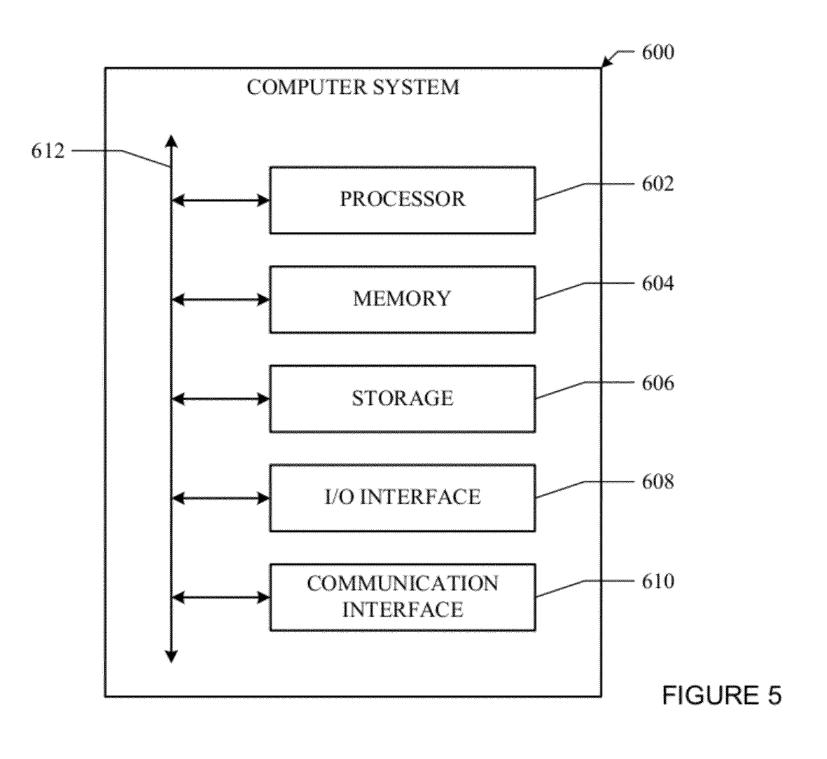

FIG. 5 illustrates an example computer system 600, which may be used with some embodiments of the present invention. This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 600 may include one or more computer systems 600; be unitary or distributed; span multiple locations; span multiple machines; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 602, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 602, or storage 606; decode and execute them; and then write one or more results to an internal register, an internal cache, memory 602, or storage 606. In particular embodiments, processor 602 may include one or more internal caches for data, instructions, or addresses. The present disclosure contemplates processor 602 including any suitable number of any suitable internal caches, where appropriate. As an example and not by way of limitation, processor 602 may include one or more instruction caches, one or more data caches, and one or more translation look-aside buffers (TLBs). Instructions in the instruction caches may be copies of instructions in memory 602 or storage 606, and the instruction caches may speed up retrieval of those instructions by processor 602. Data in the data caches may be copies of data in memory 602 or storage 606 for instructions executing at processor 602 to operate on; the results of previous instructions executed at processor 602 for access by subsequent instructions executing at processor 602 or for writing to memory 602 or storage 606; or other suitable data. The data caches may speed up read or write operations by processor 602. The TLBs may speed up virtual-address translation for processor 602. In particular embodiments, processor 602 may include one or more internal registers for data, instructions, or addresses. The present disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 602 includes main memory for storing instructions for processor 602 to execute or data for processor 602 to operate on. As an example and not by way of limitation, computer system 600 may load instructions from storage 606 or another source (such as, for example, another computer system 600) to memory 602. Processor 602 may then load the instructions from memory 602 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 602. In particular embodiments, processor 602 executes only instructions in one or more internal registers or internal caches or in memory 602 (as opposed to storage 606 or elsewhere) and operates only on data in one or more internal registers or internal caches or in memory 602 (as opposed to storage 606 or elsewhere). One or more memory buses (which may each include an address bus and a data bus) may couple processor 602 to memory 602. Bus 612 may include one or more memory buses, as described below. In particular embodiments, one or more memory management units (MMUs) reside between processor 602 and memory 602 and facilitate accesses to memory 602 requested by processor 602. In particular embodiments, memory 602 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 602 may include one or more memories 602, where appropriate. Although this disclosure describes and illustrates particular memory, this disclosure contemplates any suitable memory.

In particular embodiments, storage 606 includes mass storage for data or instructions. As an example and not by way of limitation, storage 606 may include an HDD, a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

This disclosure contemplates one or more computer-readable storage media implementing any suitable storage. In particular embodiments, a computer-readable storage medium implements one or more portions of processor 602 (such as, for example, one or more internal registers or caches), one or more portions of memory 602, one or more portions of storage 606, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method for merging an address book with social graph information relative to a first user, the method comprising:
accessing a social graph to generate a list of users that are separated by one degree from a first user, wherein the social graph comprises a plurality of nodes, each node corresponding to a respective user, and edge data identifying connections between nodes of the plurality of nodes, wherein a degree of separation between a first node and a second node in the social network graph is a minimum number of hops required to traverse from the first node to the second node;
each node corresponding to a user profile including a user name and communication channel information;
accessing an address book of the first user, the address book including one or more contact entries, each contact entry comprising a name and communication channel information;
merging user profile information from the social graph and the address book by:
matching, for each user profile associated with the list of users, the user profile to a contact entry in the address book;
if there is an exact match between the user profile and a contact entry in the address book, associating the user profile and the contact entry as a match;
if there is a partial match between the user profile and a contact entry in the address book, then
presenting the contact entry to the first user to confirm the partial match; and
associating the user profile and the contact entry as a match.

2. The method of claim 1 wherein the associating the user profile and the contact entry further comprises:
if the communication channel information of the user profile is accessible to the first user based on one ore more privacy settings, importing the communication channel information of the user profile to the contact entry of the address book.

3. The method of claim 1, further comprising:
for each user profile associated with the list of users that is not associated with a contact entry in the address book, copying the communication channel information to the address book.

4. The method of claim 1 wherein the list of users further comprises one or more users that are separated by two degrees from the first user.

5. The method of claim 1 wherein the list of users further comprises one or more users that are separated by three degrees or less from the first user.

6. The method of claim 4 wherein the associating the user profile and the contact entry further comprises presenting an option to the first user to send an invitation to a user associated with a matched user profile to establish a first-degree separation relationship.

7. The method of claim 1 wherein the address book is maintained on a mobile device.

8. A system for merging an address book with social graph information relative to a first user, the system comprising:
a memory;
one or more processors; and
a non-transitory, storage medium storing computer-readable instructions operative, when executed, to cause the one or more processors to:
access a social graph to generate a list of users that are separated by one degree from a first user, wherein the social graph comprises a plurality of nodes, each node corresponding to a respective user, and edge data identifying connections between nodes of the plurality of nodes, wherein a degree of separation between a first node and a second node in the social network graph is a minimum number of hops required to traverse from the first node to the second node;
each node corresponding to a user profile including a user name and communication channel information;
access an address book of the first user, the address book including one or more contact entries, each contact entry comprising a name and communication channel information;
merge user profile information from the social graph and the address book by:
matching, for each user profile associated with the list of users, the user profile to a contact entry in the address book;
if there is an exact match between the user profile and a contact entry in the address book, associating the user profile and the contact entry as a match;
if there is a partial match between the user profile and a contact entry in the address book, then
presenting the contact entry to the first user to confirm the partial match; and
associating the user profile and the contact entry as a match.

9. The system of claim 8, wherein to associate the user profile and the contact entry, further comprising instructions operable to cause the one or more processors to:
if the communication channel information of the user profile is accessible to the first user based on one ore more privacy settings, import the communication channel information of the user profile to the contact entry of the address book.

10. The system of claim 8, further comprising instructions operable to cause the one or more processors to:
for each user profile associated with the list of users that is not associated with a contact entry in the address book, copy the communication channel information to the address book.

11. The system of claim 8 wherein the list of users further comprises one or more users that are separated by two degrees from the first user.

12. The system of claim 8 wherein the list of users further comprises one or more users that are separated by three degrees or less from the first user.

13. The system of claim 11, wherein to associate the user profile and the contact entry, further comprising instructions operable to cause the one or more processors to present an option to the first user to send an invitation to a user associated with a matched user profile to establish a first-degree separation relationship.

14. The system of claim 8 wherein the address book is maintained on a mobile device.

15. One or more computer-readable tangible storage media embodying software operable when executed by one or more computing devices to:
access a social graph to generate a list of users that are separated by one degree from a first user, wherein the social graph comprises a plurality of nodes, each node corresponding to a respective user, and edge data identifying connections between nodes of the plurality of nodes, wherein a degree of separation between a first node and a second node in the social network graph is a minimum number of hops required to traverse from the first node to the second node;
each node corresponding to a user profile including a user name and communication channel information;
access an address book of the first user, the address book including one or more contact entries, each contact entry comprising a name and communication channel information;
merge user profile information from the social graph and the address book by:
matching, for each user profile associated with the list of users, the user profile to a contact entry in the address book;
if there is an exact match between the user profile and a contact entry in the address book, associating the user profile and the contact entry as a match;
if there is a partial match between the user profile and a contact entry in the address book, then
presenting the contact entry to the first user to confirm the partial match; and
associating the user profile and the contact entry as a match.

16. The media of claim 15, wherein to associate the user profile and the contact entry, further comprising software operable when executed by the one or more computing devices to:
if the communication channel information of the user profile is accessible to the first user based on one ore more privacy settings, import the communication channel information of the user profile to the contact entry of the address book.

17. The media of claim 15, further comprising software operable when executed by the one or more computing devices to:
for each user profile associated with the list of users that is not associated with a contact entry in the address book, copy the communication channel information to the address book.

18. The media of claim 15 wherein the list of users further comprises one or more users that are separated by two degrees from the first user.

19. The media of claim 15 wherein the list of users further comprises one or more users that are separated by three degrees or less from the first user.

20. The media of claim 18, wherein to associate the user profile and the contact entry, further comprising software operable when executed by the one or more computing devices to present an option to the first user to send an invitation to a user associated with a matched user profile to establish a first-degree separation relationship.

21. The media of claim 15 wherein the address book is maintained on a mobile device.
